(19) United States
(12) Patent Application Publication
(10) Pub. No.: US 2017/0242577 A1
(43) Pub. Date: Aug. 24, 2017

(54) METHOD FOR ESTABLISHING VIRTUAL COMMUNITY NETWORK CONNECTION AND NETWORK COMMUNICATION SYSTEM

(71) Applicant: GEMTEK TECHNOLOGY CO.,LTD., Hsinchu (TW)

(72) Inventors: Der-Hwa TAN, Hsinchu (TW); Hung-Wen CHEN, Hsinchu (TW); Hsi-Chuan WEI, Hsinchu (TW)

(73) Assignee: GEMTEK TECHNOLOGY CO.,LTD., Hsinchu (TW)

(21) Appl. No.: 15/591,053

(22) Filed: May 9, 2017

Related U.S. Application Data
(63) Continuation-in-part of application No. 14/048,922, filed on Oct. 8, 2013.

(30) Foreign Application Priority Data
Jul. 26, 2013 (TW) 102126920
Mar. 8, 2017 (TW) 106107609

(51) Int. Cl. G06F 3/0484; G06F 3/0481; G06F 3/0482; H04L 12/28

(52) U.S. Cl. CPC G06F 3/04847; H04L 12/2816; G06F 3/04817; G06F 3/0482; H04L 2012/2841

(57) ABSTRACT

A method for establishing a virtual community network connection is applied to a network communication system. The method includes obtaining first registration information, with the first registration information including an operational profile of a controlled device, with the operational profile including a plurality of operational items, providing the operational profile and a first usage permission to a first controlling device, setting a second usage permission according to the first usage permission by the first controlling device, with the second usage permission related to at least one operational item in the operational items, providing a second controlling device with the at least one operational item related to the second usage permission, and when one of the at least one operational item related to the second usage permission is activated by the second controlling device, sending an operational command corresponding to the activated operational item to the controlled device.

### CROSS-REFERENCE TO RELATED APPLICATIONS

This non-provisional application is a continuation-in-part of U.S. application Ser. No. 14/048,922 filed on Oct. 8, 2013, which claims priority under 35 U.S.C. §119(a) to Patent Application No. 102126920, filed in Taiwan R.O.C. on Jul. 26, 2013. This non-provisional application also claims priority under 35 U.S.C. §119(a) to Patent Application No. 106107609, filed in Taiwan R.O.C. on Mar. 8, 2017. The foregoing applications are incorporated herein by reference.

### BACKGROUND

Technical Field

This disclosure relates to a method for establishing a virtual community network connection, and particularly to a method for establishing a virtual community network connection between a user and a device.

Related Art

Along with the progress of technology, the number of smart phone users has been increasing day by day. The mobile applications installed in the phones are getting versatile as well so that various information and functions can be provided for the users. Furthermore, smart household devices able to communicate with mobile applications are developed accordingly. By the mobile applications, users are able to be notified of the situations of the household devices anytime and to control them remotely. For example, a washing machine can automatically notify the user when the laundry is done. If the user is not home to hang out the laundry, the user can turn on the sterilization mode of the washing machine remotely through the mobile application in order to avoid peculiar smell yielded.

However, when several people, such as all members of a family, would like to control a smart household device with their personal devices respectively, each of the personal devices has to be set up for the linkage with the smart household device, or the linkages respectively for the personal devices have to be set up on the smart household device. In addition, when the owner, such as a landlord, wants to provide the smart household device for others, such as one or more tenants, the linkage set up between the personal devices of the tenants and the smart household device may bring the tenants the usage permission equivalent to that of the landlord. The setting steps of the linkage aforementioned are not only complicated but highly possible to cause the usage permission completely authorized to others.

### SUMMARY

According to an embodiment of this disclosure, a method for establishing a virtual community network connection is applied to a network communication system. The method includes obtaining first registration information, with the first registration information including an operational profile of a controlled device, with the operational profile including a plurality of operational items; providing the operational profile and a first usage permission to a first controlling device; setting a second usage permission according to the first usage permission by the first controlling device, with the second usage permission related to at least one operational item in the operational items; providing a second controlling device with the at least one operational item related to the second usage permission; and when one of the at least one operational item related to the second usage permission is activated by the second controlling device, sending an operational command to the controlled device, with the operational command corresponding to the activated operational item.

According to an embodiment of this disclosure, a network communication system includes a server. The server executes the method for establishing a virtual community network connection as described in the above embodiment.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a functional block diagram of a network communication system in an embodiment of this disclosure;

FIG. 2 is a flowchart of a method for establishing a virtual community network connection in an embodiment of this disclosure;

FIG. 3 is a schematic diagram of a user interface provided to a first controlling device by a network communication system in an embodiment of this disclosure;

FIG. 4A is a schematic diagram of a user interface in an embodiment of this disclosure, with a network communication system provides a share setting item to a first controlling device by said user interface;

FIG. 4B is a schematic diagram of a user interface in another embodiment of this disclosure, with a network communication system provides a share setting item to a first controlling device by said user interface;

FIG. 4C is a schematic diagram of a user interface in yet another embodiment of this disclosure, with a network communication system provides a share setting item to a first controlling device by said user interface;

FIG. 5 is a schematic diagram of a user interface in an embodiment of this disclosure, with a network communication system provides operational items to a first controlling device by said user interface;

FIG. 6A is a schematic diagram of a user interface in an embodiment of this disclosure, with a network communication system provides operational items to a second controlling device by said user interface; and

FIG. 6B is a schematic diagram of a user interface in another embodiment of this disclosure, with a network communication system provides operational items to a second controlling device by said user interface.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

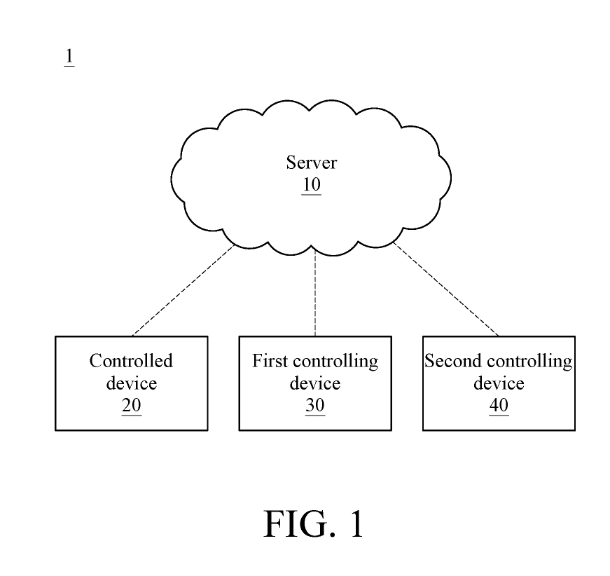

Please refer to FIG. 1. FIG. 1 is a functional block diagram of a network communication system in an embodiment of this disclosure. As shown in FIG. 1, a network communication system 1 includes a server 10 such as a cloud server. The server 10 has a communication connection to a controlled device 20, a first controlling device 30 and a second controlling device 40. The controlled device 20 is a hardware device owned by a first user, such as a television, a lamp, or a monitor. This disclosure does not intend to limit the type of the controlled device 20. For example, the first controlling device 30 is a smart phone, a personal computer, or other personal device of the first user, and the second controlling device 40 is a smart phone, a personal computer, or other personal device of a second user. In an embodiment of this disclosure, the first user can use the first controlling device 30 to share functions of the controlled device 20 to the second user via the network communication system 10. Therefore, the second user can control the controlled device 20 via the second controlling device 40. In other words, the first user may authorize the second user, via the network communication system 10, to use the functions of the controlled device 20. Moreover, the method for the authorization of the controlled device 20 by the network communication system 10 is described in detail as follows.

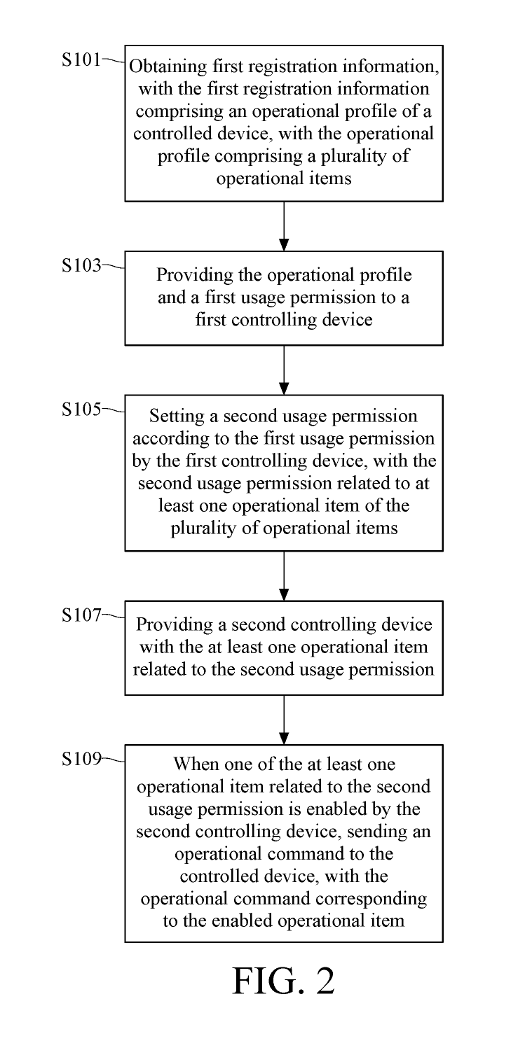

Please refer to FIG. 1 and FIG. 2. FIG. 2 is a flowchart of a method for establishing a virtual community network connection in an embodiment of this disclosure. In this embodiment, method for establishing a virtual community network connection is applied to the network communication system as shown in FIG. 1. In an embodiment, the server 10 of the network communication system 1 can include a binding processor to execute operations of the server 10 as described in the following.

In step S101, the server 10 obtains first registration information. The first registration information includes an operational profile of the controlled device 20. The operational profile includes a plurality of operational items. More specifically, the controlled device 20 signs up with the server 10 to provide the first registration information thereto, with the first registration information including the operational profile. For example, communication software (e.g. cloud agent) for communicating with the server 10 is installed in the controlled device 20 during manufacturing process of the controlled device 20. The communication software contains a registration interface. The server 10 is capable of obtaining the first registration information of the controlled device 20 by the communication software. Besides being installed in the controlled device 20 during the manufacturing process, the communication software can also be installed in the controlled device 20 via the Internet by the first user once the first user has the controlled device 20. This disclosure does not intend to limit when the communication software is installed in the controlled device 20. In an embodiment, the controlled device 20 automatically signs up with the server 10 via the communication software as plugged in or enabled. Then server 10, then, stores the first registration information, such as a product number, service items, shareable items or other information, provided by the controlled device 20. This disclosure does not intend to limit the kind of the first registration information. In another embodiment, the controlled device 20 is signed up with the server 10 by a person; it is not limited in this disclosure.

In step S103, the server 10 provides the first controlling device 30 with the operational profile and a first usage permission. The first usage permission indicates which operational permission of the controlled device 20 the owner; that is the first user holds. In other words, the first usage permission indicates which operational item of the controlled device 20 can be executed by the owner. In this step, the server 10 transmits the operational profile of the controlled device 20 and the first usage permission to the personal device of the owner (i.e. first controlling device 30).

In an embodiment, the first registration information, provided by the controlled device 20 in the step S101, includes an identifier related to the first controlling device 30. Therefore, according to this identifier, the server 10 is capable of transmitting the operational profile of the controlled device 20 and the first usage permission to the first controlling device 30. In another embodiment, the first registration information provided by the controlled device 20 includes a verification code related to the controlled device 20, and the owner of the controlled device 20 has said verification code. When the server 10 receives information to be verified and a request from the first controlling device 30, with the request for establishing a connection with the controlled device 20, the server 10 determines whether the information to be verified is equivalent to the verification code of the controlled device 20. When the server 10 determines that the information to be verified is equivalent to the verification code of the controlled device 20, it means that the first controlling device 30 is the personal device of the owner of the controlled device 20. Therefore, the server 10 provides the first controlling device 30 with the operational profile and the first usage permission. The method by which the server 10 provides the information to the first controlling device 30 will be explained in detail in the later embodiment.

In step S105, the first controlling device 30 sets a second usage permission according to the first usage permission. The second usage permission is related to at least one of the operational items of the controlled device 20. In an embodiment, the first usage permission includes an operating permission and a sharing permission. The first controlling device 30 can be used to set the second usage permission according to the sharing permission. For example, the controlled device 20 is a monitor and its operational items include “start playing”, “start recording”, “look up parameters”, and so on. The first usage permission includes the operating permission of the above three operational items, and the sharing permission for setting one or more of the above three operational items being included in the second usage permission. The first user can set the second usage permission of the controlled device 20 and providing the second usage permission to the server 10 via the first controlling device 30. In other words, the first user can share one or more operational items of the controlled device 20 to the second user.

Afterwards, in step S107, the server 10 provides the second controlling device 40 with the one or more operational items related to the second usage permission. In an embodiment, the first user may provide an identifier related to the second controlling device 40 as providing the second usage permission to the server 10. Then, the server 10 provides the operational items to the second controlling device 40 according to the second usage permission and the identifier. The method by which the server 10 provides the information to the second controlling device 40 will be explained in detail in the later embodiment.

In step S109, when one of the operational items related to the second usage permission is activated by the second controlling device 40, an operational command corresponding to the activated operational item is transmitted to the controlled device 20. In other words, the second user may activate one of the operational items via the second controlling device 40 to operate the controlled device 20, with the operational items shared by the first user. The method for activating the operational item via the second controlling device 40 will be explained in detail in the later embodiment. In an embodiment, when one of the operational items related to the second usage permission is activated by the second controlling device 40, an operational command corresponding to the activated operational item is generated, and then the server 10 transmits the operational command to the controlled device 20.

In another embodiment, the second controlling device 40 receives not only the operational items related to the second usage permission but also an identifier related to the first controlling device 30 from the server 10. Therefore, the second controlling device 40 is capable of generating an operational command and then directly transmitting the operational command to the controlled device 20, with the operational command corresponding to the activated operational item and including the identifier of the first controlling device 30. When the controlled device 20 receives the operational command from the second controlling device 40 and determines the operational command is related to the authorization from the first controlling device 30 (the owner of the controlled device 20) according to the identifier of the first controlling device included in the operational command, the controlled device 20 executes the operational command. In this embodiment, the controlled device 20 is capable of communicating with the second controlling device 40 by a short-range wireless communication technology, such as Wi-Fi, Bluetooth or ZigBee, which is not limited in this disclosure.

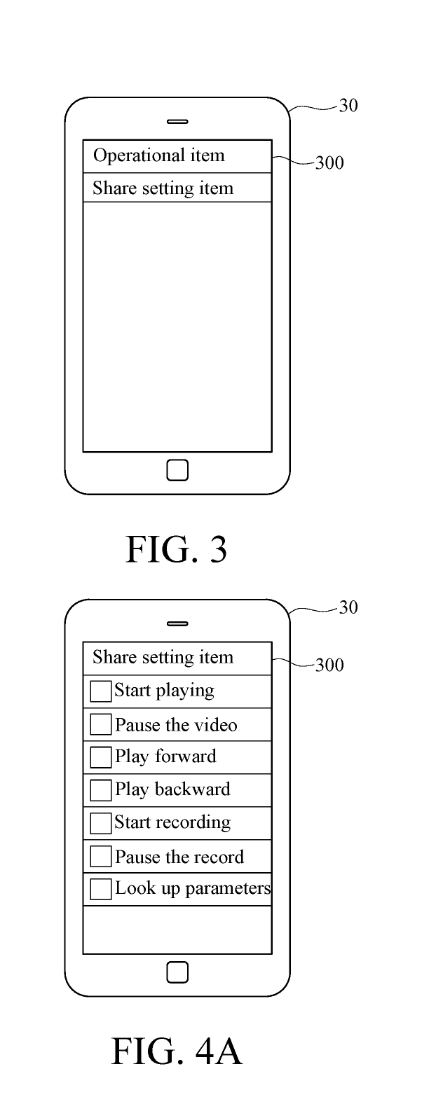

The method for providing the operational profile and the first usage permission to the first controlling device 30 by the server 10 is described in the following. Please refer to FIG. 1 and FIG. 3. FIG. 3 is a schematic diagram of a user interface provided to a first controlling device by a network communication system in an embodiment of this disclosure. In this embodiment, the server 10 provides the operational profile and the first usage permission of the controlled device 20 to the first controlling device 30 by providing a user interface 300. More specifically, as shown in FIG. 3, the user interface 300 displays an operational item and at least one share setting item, with the user interface 300 provided in the first controlling device 30 by the server 10. The operational item is related to the operating permission included in the first usage permission, and the share setting item is related to the sharing permission included in the first usage permission. The operating permission indicates which function of the controlled device 20 can be operated by the first controlling device 30. On the other hand, the sharing permission indicates that the first controlling device 30 can share the functions of the controlled device 20 to other controlling device. In the following statement, the controlled device 20 is exemplified by a monitor for the illustration of the user interface, but this disclosure does not intend to limit the type of the controlled device 20.

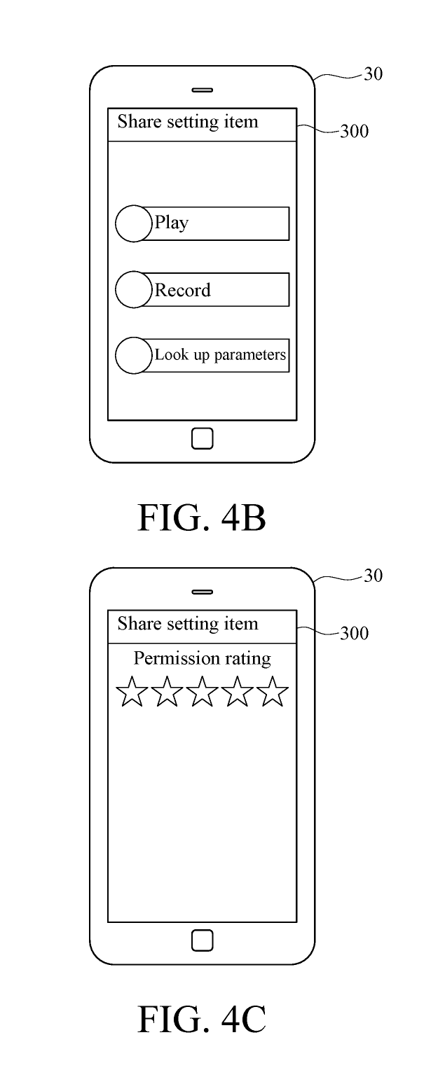

Please refer to FIG. 4A, 4B and 4C. FIG. 4A is a schematic diagram of a user interface in an embodiment of this disclosure, with a network communication system provides a share setting item to a first controlling device by said user interface, FIG. 4B is a schematic diagram of a user interface in another embodiment of this disclosure, with a network communication system provides a share setting item to a first controlling device by said user interface, and FIG. 4C is a schematic diagram of a user interface in yet another embodiment of this disclosure, with a network communication system provides a share setting item to a first controlling device by said user interface. When the first user clicks the “share setting item” as shown in FIG. 3 via the user interface 300 of the first controlling device 30, a display picture for share setting is displayed.

In an embodiment, as shown in FIG. 4A, the share setting item is displayed in a list on the user interface 300. For example, when the controlled device 20 is a monitor, the list displayed on the user interface 300 shows the operational items of the monitor, such as “start playing”, “pause the video”, “play forward” and so on.

In another embodiment, the share setting item is displayed by categories. As shown in FIG. 4B, a display picture of the user interface 300 is related to the share setting item, and displays three categories, “play”, “record” and “look up parameters”. Therefore, the first user merely has to select the category to share all operational items included in the selected category. For example, when “play” is selected, the operational items belonging to the operation of playing a video are shared, with the operational items includes “start playing”, “pause the video”, “play forward” and “play backward”, as shown in FIG. 4A.

In yet another embodiment, the share setting item is shown as hierarchical permission setting. More specifically, as shown in FIG. 4C, the first user can decide the number of stars for setting a permission rating, and each permission rating corresponds to the specific amount of the operational items. For example, the permission rating of five stars indicates that all the operational items are shared. Therefore, when the first user would like to share all the operational items to another person, the first user does not have to select the operational items one by one. As another example, the permission rating of one star indicates that merely the functions of “start playing” and “pause the video”, as shown in FIG. 4A, are shared. Therefore, the first user does not have to search for the above two operational items from the list including various operational items. The first user can share those two operational items by selecting one star. The display approach of the permission rating on the user interface and the relation between the permission rating and the operational items are merely exemplified in the above statement, and are not limited to these examples.

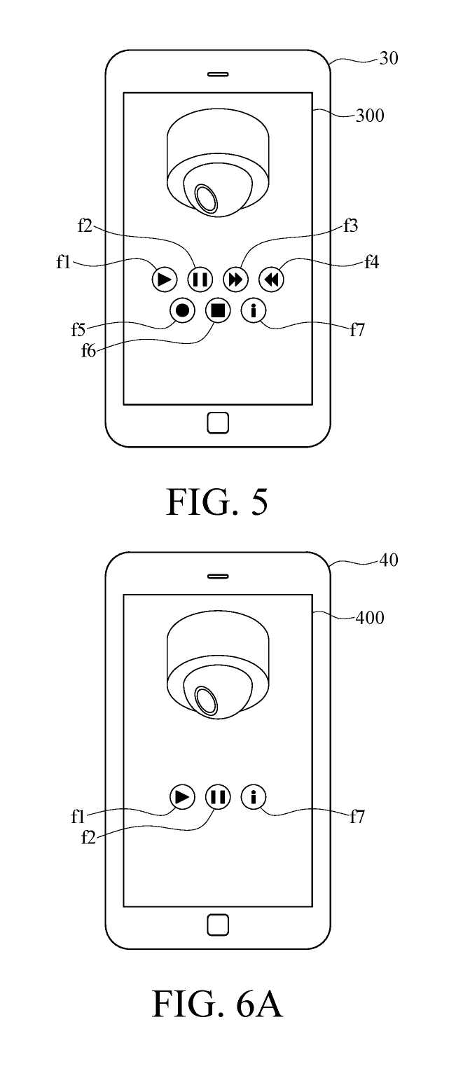

The embodiments in FIG. 4A-4C are exemplified as display pictures of the user interface 300 when the first user clicks the “share setting item” via the user interface 300 as shown in FIG. 3. Please refer to FIG. 5. FIG. 5 is a schematic diagram of a user interface in an embodiment of this disclosure, with a network communication system provides operational items to a first controlling device by said user interface. When the first user clicks the “operational item” via the user interface 300 as shown in FIG. 3, the user interface 300 displays the operational items of the controlled device 20. For example, as shown in FIG. 5, when the controlled device 20 is a monitor, the operational items are respectively displayed as button icons f1-f7 on the user interface 300. For example, the button icon f1 corresponds to the operational item “start playing” of the monitor, the button icon f2 corresponds to the operational item “pause the video”, the button icon f7 corresponds to the operational item “look up parameters”, and so on. Therefore, when the first user activates one of the button icons f1-f7, the first controlling device 30 generates an operational command which corresponds to the operational item corresponding to the activated button icon. Then, the operational command is transmitted to the controlled device 20.

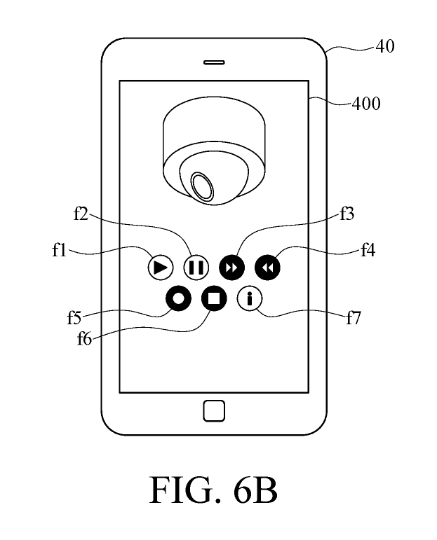

The server 10 is capable of providing the second controlling device 40 with the operational items related to the second usage permission by the method similar to the method by which the server 10 provides the first controlling device 30 with the operational items, as mentioned before. Please refer to FIG. 6A and 6B. FIG. 6A is a schematic diagram of a user interface in an embodiment of this disclosure, with a network communication system provides operational items to a second controlling device by said user interface, and FIG. 6B is a schematic diagram of a user interface in another embodiment of this disclosure, with a network communication system provides operational items to a second controlling device by said user interface. The server 10 is capable of instructing the user interface 400 of the second controlling device 40 to display the operational items related to the second usage permission.

In an embodiment, as shown in FIG. 6A, the controlled device 20 is exemplified by the monitor. When the second usage permission, set by the first controlling device 30, includes the operating permission of three operational items, “start playing”, “pause the video” and “look up parameters”, the server 10 is capable of instructing the user interface 400 to display the above three operational items as button icons f1, f2 and f7. When the second user activates one of the button icons f1, f2 and f7, the second controlling device 40 generates an operational command and then the operational command is transmitted to the controlled device 20. The operational command corresponds to the operational item and the operational item corresponds to the activated button icon. As shown in FIG. 5 and FIG. 6A, because the server 10 instructs the user interface 400 of the second controlling device 40 to display the operational items according to the second usage permission, the operational items displayed on the user interface 400 are part of or all of the operational items displayed on the user interface 300 of the first controlling device 30.

In another embodiment, the user interface 400 is also capable of selectively displaying the operational items not related to the second usage permission besides the operational items related to the second usage permission. For example, as shown in FIG. 6B, the user interface 400 of the second controlling device 40 displays the button icons f1-f7 the same as these displayed on the user interface 300 of the first controlling device 30 in FIG. 5. However, the button icons f3-f6 does not correspond to the operational items included in the second usage permission, so the button icons f3-f6 are displayed in gray and cannot be selected. Therefore, the second user can know all of the operational items of the controlled device 20 through the user interface 400, but merely execute the operational items included in the second usage permission. The operational items are illustrated with the button icons in the above embodiments, but the operational items can be displayed as options or patterns, or in other form; it's not limited in this disclosure.

Moreover, the owner (first controlling device 30) of the controlled device 20 is capable of sharing the operational functions of the controlled device 20 to the second controlling device 40 and further to the third controlling device. When the first user sets the share setting item via the first controlling device 30, the user interface 300 further provides not only the setting for selecting which operational item to share but also the setting for selecting which person to share with. The first user can input or select the identifiers of the second controlling device 40 and the third controlling device by setting for selecting which person to share with, and then the server 10 provides the second controlling device 40 and the third controlling device with the operational item which the first user would like to share according to the second usage permission set by the first user and the identifiers provided by the first user. This disclosure does not intend to limit how many controlling devices the first controlling device 30 shares the operational item of the controlled device 20 with.

In an embodiment, the aforementioned user interface 300 and 400 refer to communication software (e.g. cloud agent) respectively installed in the first controlling device 30 and the second controlling device 40. The first controlling device 30 and the second controlling device 40 are capable of communicating with the server 10, as a communication platform, via the communication software. Besides the first registration information of the controlled device 20, the server 10 is also capable of obtaining the second registration information of the first controlling device 30 and the third registration information of the second controlling device via the communication software. In this embodiment, when the first controlling device 30 is verified to be the owner of the controlled device 20 by the verification method described as the said embodiment, the controlled device 20 becomes a friend of the first controlling device 30 in the communication software. The first controlling device 30 can be used to create a chat-room and invite the controlled device 20 chat-room to join for controlling the controlled device 20. Therefore, when the first user owns a number of controlled devices, the first user does not have to open a number of application programs for respectively controlling the controlled devices 20, with the application programs respectively corresponding to the controlled devices. The first user merely has to create chat-rooms and respectively invite the controlled devices to join by the communication software of the controlling device 30. It simplifies the process of establishing the connection between smart devices.

Moreover, the first controlling device 30 is also capable of creating a chat-room and inviting the controlled device 20 and the second controlling device 40 simultaneously by the share setting item as described in the above embodiment to share the operational functions of the controlled device 20 to the second controlling device 40. Otherwise, the first controlling device 30 may be used to invite the second controlling device 40 to a chat-room, with the controlled device 20 having already joined the chat-room. Therefore, the first controlling device 30 can be used to share the operational functions of the controlled device 20 to the second controlling device 40. Besides clicking the button icon to control the controlled device 20 as described in the above embodiment, the first user and the second user is also capable of controlling the controlled device 20 by a natural language, such as typing or speaking the operational item in the natural language. This disclosure does not intend to limit the method for activating the operational item to control the controlled device 20. Therefore, the owner of the controlled device 20 can set the second usage permission via the first controlling device 30 to share the operational functions of the controlled device 20 to the second controlling device 40 of another person. For example, the owner creates a chat-room including the controlled device 20 and the second controlling device 40 via the first controlling device 30 rather than sets up the linkage between the second controlling device 40 and the controlled device 20 via either of them. Moreover, the owner can cancel the second usage permission via the first controlling device 30, in order to disable the second controlling device 40 from executing the operational items of the controlled device 20 which have been shared to the second controlling device 40. For example, the owner removes the second controlling device 40 from the chat-room to cancel the second usage permission corresponding to the second controlling device 40.

In a practical example, when a landlord rents a house out to a tenant, the landlord can add the tenant into a chat-room including a household device such as a lamp, a television or an air condition via the communication software installed in the landlord's cell phone, in order to share the operational functions of the household device to the tenant. Therefore, the tenant can control the household device via the chat-room. On the other hand, when the tenant moves out, the landlord can remove the tenant out of the chat-room to cancel the operational permission of the household device for the tenant.

Moreover, the owner can freely select the number of people for sharing the controlled device 20. For example, the owner has a number of controlled devices 20 including a lamp and a monitor. The owner may create a chat-room including the lamp, a second controlling device 40 and a third controlling device 50, and creating another chat-room including a monitor and the second controlling device 40. In addition, the owner may create a number of chat-rooms, with each of the chat-rooms including the same controlled device 20 but all of them being set to have different second usage permission. Furthermore, the users except the owner in the same chat-room have the same operational permission of the same controlled device 20.

In view of the above description, the method for establishing a virtual community network connection and the network communication system provided in this disclosure provides an operational profile and first usage permission to the owner of the controlled device (i.e. the first controlling device), with the operational profile including a number of operational items, and then sets second usage permission via the first controlling device to provide the operational item related to the second usage permission to the second controlling device for allowing the second controlling device to control the controlled device. The second controlling device can have part of operational permission of the controlled device without being set to have a linkage with the controlled device. Besides, rather than delete the linkage between the second controlling device and the controlled device via either of them, the owner can merely cancel the second usage permission to disable the second controlling device from controlling the controlled device. Moreover, rather than open a number of mobile applications respectively corresponding to a number of controlled devices, the owner of the controlled devices can register the controlled devices and the personal device on the same network communication system to respectively control the controlled devices. Therefore, the setting steps of the linkage between the controlling device and the controlled device may be simplified, and the usage permission of the controlled device held by the owner may not be completely shared when the owner would like to share the operational items of the controlled device to others.

What is claimed is:

1. A method for establishing a virtual community network connection and applied to a network communication system, and the method comprising:
obtaining first registration information, with the first registration information comprising an operational profile of a controlled device, with the operational profile comprising a plurality of operational items;
providing the operational profile and a first usage permission to a first controlling device;
setting a second usage permission according to the first usage permission by the first controlling device, with the second usage permission related to at least one operational item of the plurality of operational items;
providing a second controlling device with the at least one operational item related to the second usage permission; and
when one of the at least one operational item related to the second usage permission is activated by the second controlling device, sending an operational command to the controlled device, with the operational command corresponding to the activated operational item.

2. The method according to claim 1, further comprising:
when one of the plurality of operational items related to the first usage permission is activated by the first controlling device, sending another operational command to the controlled device, with the operational command corresponding to the activated operational item.

3. The method according to claim 1, wherein the first usage permission comprising an operating permission and a sharing permission.

4. The method according to claim 1, wherein providing the operational profile and the first usage permission to the first controlling device comprises:
displaying at least one share setting item on an user interface.

5. The method according to claim 4, wherein the at least one share setting item is displayed in a list on the user interface.

6. The method according to claim 4, wherein the at least one share setting item is classified into at least one category and the at least one category is displayed on the user interface.

7. The method according to claim 1, wherein providing the second controlling device with the at least one operational item related to the second usage permission comprising:
displaying the at least one operational item related to the second usage permission on an user interface.

8. The method according to claim 7, wherein providing the at least one operational item related to the second usage permission to the second controlling device comprising:
selectively displaying one or more operational items, which are not related to the second usage permission, of the plurality of operational items on the user interface.

9. The method according to claim 7, wherein the at least one operational item related to the second usage permission is displayed as a button icon on the user interface.

10. The method according to claim 1, wherein providing the operational profile and the first usage permission to the first controlling device comprising:
displaying the plurality of operational items on an user interface.

11. The method according to claim 10, wherein each of the plurality of operational items is displayed as a button icon on the user interface.

12. The method according to claim 1, wherein obtaining the first registration information comprising:
obtaining the first registration information from a registration interface in the controlled device.

13. The method according to claim 1, further comprising:
obtaining second registration information of the first controlling device.

14. The method according to claim 1, further comprising:
obtaining third registration information of the second controlling device.

15. A network communication system, comprising a server, wherein the server executes the method for establishing the virtual community network connection according to claim 1.
